(19) United States
(12) Patent Application Publication
(10) Pub. No.: US 2017/0003419 A1
(43) Pub. Date: Jan. 5, 2017

(54) COATINGS FOR EXTREME ULTRAVIOLET AND SOFT X-RAY OPTICS

(71) Applicant: Supriya Jaiswal, San Diego, CA (US)

(72) Inventor: Supriya Jaiswal, San Diego, CA (US)

(21) Appl. No.: 15/198,291

(22) Filed: Jun. 30, 2016

Related U.S. Application Data
(60) Provisional application No. 62/186,741, filed on Jun. 30, 2015.

(51) Int. Cl. G02B 1/10; G21K 1/06

(52) U.S. Cl. CPC G02B 1/10; G21K 1/062

(57) ABSTRACT

Coatings for use in the extreme ultraviolet/soft X-ray spectrum/DUV from 0.1 nm to 250 nm include one or more sub-wavelength “A-layers” alternating with sub-wavelength “B-layers.” The A-layers may include Group 1, Group 2 and Group 18 materials. The B-layers may include transition metal, lanthanide, actinide, or one of their combinations. The A-layers and/or the B-layers may include nanostructures with features sized or shaped similarly to expected defects. Additional top layers may include higher-atomic-number A-layer materials, hydrophobic materials, or charged materials. Such a material may be used to make components such as mirrors, lenses or other optics, panels, lightsources, photomasks, photoresists, or other components for use in applications such as lithography, wafer patterning, astronomical and space applications, biomedical, biotech applications, or other applications.

### RELATED APPLICATIONS

This application claims priority to U. S. Prov. Pat. App. Ser. No. 62/186,741 filed 30 Jun. 2015 the entirety of which is incorporated by reference herein.

### FIELD

Related fields include design and fabrication of optical coatings, and more particularly reflective, transmissive, or wavelength-selective coatings for wavelength ranges strongly absorbed by many traditional optical materials.

### BACKGROUND

Extreme ultraviolet light (EUV, 10-120 nm wavelength) and soft x-rays (SX, 0.1-10 nm wavelength) and Deep Ultraviolet Light (DUV, 120 nm-250 nm) are part of a possible approach to lithography with resolution <22 nm, facilitating further miniaturization of integrated electronic components. Other applications include analytical chemistry (e.g., identifying chemicals by their optical resonances); astronomy (e.g., mapping nebulae, planets and stellar atmospheres; biology (study of biomaterial samples); and medicine (imaging and contaminant cleaning).

Applications requiring a sharp image or tightly focused spot with above-threshold continuous-wave power or pulsed energy may make use of beam-shaping optics (e.g., lenses or curved mirrors); beam-patterning optics (e.g., photomasks or diffusers); beam-dividing optics e.g., beamsplitters, filters, or diffraction gratings); or, depending on the required optical path length and the size or shape of the system baseplate, beam-steering optics e.g., flat mirrors or prisms.

Each passive optical element on the optical path from a light source to a target such as a workpiece or photodetector introduces light losses through absorption, scattering, vignetting, and other loss mechanisms. The losses cumulatively reduce the efficiency (fraction of source light reaching the workpiece) of the system, If low efficiency reduces the light at the target to below the practical threshold for the application, a more powerful or energetic light source may be needed in order to compensate some of the loss.

Losses may be a sizable concern in the EUV/SX/DUV wavelength range. Because many elements' atomic resonances correspond to EUV/SX wavelengths, and/or because EUV photon energies exceed the bandgaps of all materials, virtually all materials exhibit significant absorption at those wavelengths, the more powerful the EUV/SX/source (e.g., plasmas, synchrotrons) need to be to deliver an above-threshold level of light to a target, the more it costs and the more it may dissipate waste heat that can degrade focus or image quality in a number of ways. The desired power level for lithography is approximately 200 W. Limitations of EUV/SX sources are believed to be a dominant factor in the persistently slower speed of EUV/SX lithography compared to immersion lithography.

Excessive absorption of EUV/SX light from a strong source can damage optics in the beam train. Because damaged films absorb more light than undamaged films, the damage threshold decreases as the amount of existing damage increases. That is, damage accelerates once it has started. Ruthenium capping layers may be used to protect the optics, but the thickness may be restricted to 2.5 nm or less to avoid more light loss due to absorption. These thin caps slow down the onset of ablation and other damage, but continuous or repeated exposure wears away the capping layer, leaving the underlying film stack unprotected.

Some EUV/SX sources, such as plasmas, emit particles as well as light. These particles may contaminate the workpiece/wafer, the optics, the mask, and/or walls and other hardware in the process chamber. In general, pellicles may be placed to block contaminant particles from the optical path, but pellicles for EUV/SX may be difficult to make because conventional pellicle materials absorb EUV/SX light.

Common EUV/SX coatings for transmission, reflection, and filtering include alternating layers of boron-silicon (B—Si), tungsten-carbon (W—C), tungsten-boron-carbon (W—B—C). One EUV/SX film stack uses alternating layers of molybdenum and silicon (Mo—Si). Reflective coatings of this type are approximately ˜67% efficient at wavelengths near 13.5 nm. Absorption in the silicon is often the limiting factor. The maximum number of layer pairs, or periods, may be limited to approximately 40 or less.

Therefore, science and industry would benefit from rugged, low-absorption coatings to enhance transmission and reflection in the EUV/SX wavelength range.

### SUMMARY

A coating for an optical substrate is designed for a particular operating wavelength λ and operating incident angle θ. The coating may include a first layer (“A-layer”) composed essentially of alkali metal, noble gas, halogen, alkaline earth metals except beryllium, or one of their combinations. The materials and combinations may include single elements, isotopes, ions, compounds, alloys, mixtures, nanolaminates, non-stoichiometric variations, or ternary material or other combinations. In some embodiments, the coating material may be selected from a smaller group that includes alkali metal, noble gas, and their combinations.

The thickness of the first layer may be less than λ. In the EW/SX/DW range between 0 1 nm≦λ≦250 nm and at sub-wavelength thicknesses, some non-classical layer thicknesses may perform as well as, or even better than, classical interference layers in which the thickness is an integer multiple of λ/(4 n₁ cos(θ)), with λ being the operating wavelength, n₁ the real part of the complex refractive index of the first layer at wavelength λ, and θ the incident angle relative to a surface normal. The non-classical solutions may be found numerically using finite-element calculations.

A noble-gas component may be included in the first layer as a noble-gas compound, e.g., XeF₆. If the noble-gas compound is a strong oxidizer, an oxidation barrier on either or both sides of the noble-gas compound may prevent the noble-gas compound from oxidizing neighboring materials. In embodiments where only the outer layers of a film stack are at risk of exposure to oxygen (for example, when process chambers or the like are opened to the atmosphere in order to clean or replace optics or other hardware), the oxygen barriers may be selectively formed in those outer layers. Preferably, the oxidation barrier, where present, is factored into the design equations so as not to compromise the coating's performance.

Optionally, a capping layer with a higher damage threshold than the first layer may be placed between the first layer and the surrounding environment. The capping material is selected from higher-atomic-number members of the first layer's material set. The capping layer may protect the first layer from particle or EUV/SX damage. In some embodiments, the capping layer is electrically charged, enabling the layer to repel or deflect incoming particles of like charge before they can reach the optical surface and become defects. For example, plasmas based on spraying molten tin tend to emit positively charged particles. Preferably, the capping layer is factored into the electromagnetic equations so as not to compromise the coating's performance

Optionally, a hydrophobic layer may be formed between the first or topmost layer and a source of liquid, such as the outside environment or a hygroscopic substrate. Known hydrophobic layers, such as polymers, monolayers (self-assembling and otherwise), or nanostructured films, may be used. The hydrophobic layer having a high surface energy prevents liquid absorption that may otherwise accelerate EUV/SX absorption and damage. e.g. plasma tin droplet system. Preferably, the hydrophobic layer is factored into the design equations so as not to compromise the coating's performance. In some embodiments where the coated optical element is expected to remain in use through the ablation of one or more of the coating's outer layers, multiple hydrophobic layers may be interspersed through some portion of the stack such that if one hydrophobic layer is ablated away, another is soon uncovered.

A second layer (“B-layer”) may be formed above or below the first layer so that the two layers together constitute a period or layer pair. The second layer's composition may essentially consist of transition metal, lanthanide, actinide, or one of their combinations. The second layer may include single elements, isotopes, ions, compounds, alloys, mixtures, nanolaminates, non-stoichiometric variations, or ternary material, or other combinations. In some embodiments, the second layer is selected from period 5 of groups 3-9 (Y, Zr, Nb, Mo, Tc, Ru, Rh, Pd, Ag., Cd). As with the first layer, the second layer's thickness is less than λ. In the EUV/SX range between 0.1 nm≦λ≦120 nm and at sub-wavelength thicknesses, some non-classical layer thicknesses may perform as well as, or even better than, the classical interference layers where the thickness of the second layer is an integer multiple of λ/(4 n₂ cos(θ), where λ is the wavelength, n₂ is the real part of the complex refractive index of the second layer at wavelength λ relative to the incident medium, and 0 is the incident angle relative to a surface normal. These solutions may be found numerically using finite-element calculations. The first layer may have lower absorption than Si or the second layer. The second layer may have a real part of its refractive index more different from that of the surrounding environment (e.g., air, gas, vacuum) than the first layer.

In some embodiments, the second layer may be nonporous and first layer may be porous such that pores filled layer with a less-absorptive substance such as gas(es), vacuum, or a filler replace part of the optical path through the first layer. The pores may be open to the surrounding environment, or may be sealed. Open pores may allow injected noble gas to flow through the layer. Sealed pores may contain gas trapped during the formation of the layer, e.g., by bubble nucleation. The pores may be etched pits or channels, may constitute a void structure, or may be spaces in a crystalline lattice. Optionally, one or more pores may be used to admit or contain a noble-gas component of the first layer's composition. The aggregation of pores serve to reduce the overall bulk density of the material, and may be uniformly dispersed through out the second layer so as to present a layer with an isotropic reduced density material.

To increase or decrease the reflectivity of the optical element even more, multiple periods of the first layer and the second layer may be stacked. The lower absorption of the first layer compared to traditional Si may make stacks of 40-400 layers practical as a way of enhancing reflectivity, or of extending the life of the optical element as successive layers are ablated. In some embodiments, the stack may include only periods of the same first layer with the same second layer. Alternatively, the stack may use two or more composition options of first layer and second layer. For example, the outermost layers may be formulated for high damage threshold and the inner layers may be formulated for low absorption. In some embodiments, the combined thickness of a first layer and a second layer may be less than λ. The layers may also be graded with a range of periods from top to bottom of the multi-stacked layer. In some embodiments the order of layer A and layer B as a first and second layer (ABABAB) may be reversed (BABABA).Optionally, any layer in the stack may be stoichiometric or non-stoichiometric.

Optionally, a capping layer or one or more other layers may be charged to repel charged particles coming from the plasma or other EUV/SX source. The charge may be imparted by ions incorporated in the layer, or may be imposed by connecting the capping layer or an adjacent layer to an ungrounded electric field, e.g., via a contact. The capping layer may also be made of a material that has a higher atomic number than Ruthenium, producing a higher interatomic repulsion potential. This reduces the ion stopping distance of incoming bombarding particles, into the coating.

An optical reflector may include at least one porous low-absorption layer and one non-porous high-reflective layer, each with a sub-wavelength thickness. Optionally, the sum of thicknesses of the first and second layers is also less than the operating wavelength. Optionally, the pores in the porous layer may be spaces or voids in a nanostructure.

Defectivity is a significant issue in EUV lightsource systems, especially if a plasma source is present. The plasma source generates many ions which become embedded in other components in the system, and consequently destroy coatings, capping layers, lenses, mirrors, filters, photomasks. When a defect is present or partially embedded in a multilayer it compromises the reflectivity of the coating. In some embodiments, the first layer, the second layer, or both may include a nanostructure having features that optically hide the visibility of defects.

A method of making an optical element may include preparing a substrate: and forming a first layer above the substrate. The first layer may be essentially composed of alkali metal, noble gas, halogen, alkaline earth metal except for beryllium, or one of their combinations. The first layer may have a sub-wavelength thickness for an operating wavelength between 0.1 nm and 250 nm. A second layer of sub-wavelength thickness may be formed above or below the first layer; the second layer may be essentially composed of transition metal, lanthanide, actinide, or one of their combinations.

The multilayer or its constituents may be produced by deposition processes including on or more of sputtering, evaporation, thermal or e-beam evaporation, pulsed laser deposition, atomic layer deposition, molecular layer deposition, atomic layer epitaxy, ion beam deposition, e-beam deposition, electrodeposition, electro-formation, chemical vapor deposition, plasma enhanced deposition, physical vapour deposition, chemical vapor depositions, pulsed chemical, vapor deposition, laser excitation, epitaxy, pulsed laser deposition, spin coating, drop coating, spray deposition, pyrolysis. Smoothing of the multilayer films may be achieved by chemical mechanical polishing, template stripping, or AFM/SEM, electron beam or ion beam radiation, vapour annealing, atomic layer etching, nanoparticle slurry etching, or other planarization steps.

Multilayer combinations which consist of Layer A-Layer B combinations as an alternating first and second layers present a better alternative to Mo—Si multilayers. They have more resistance and tolerance to defects due to their larger interatomic potential, robustness, and tensile strength. Defectivity is a significant issue in EUV lightsource systems, especially a plasma source is present. The plasma source generates many ions which become embedded in other components in the system, and consequently destroy coatings, capping layers, lenses, mirrors, filters, photomasks. When a defect is present or partially embedded in a multilayer it compromises the reflectivity of the coating. By simulation and experiment the reflectivity tradeoff per layer destroyed can be calculated for different material combinations. Reflectivity tradeoff calculated as reduction in peak reflectivity per destroyed layer, as a percentage of the peak reflectivity:

Reflectivity trade-off=100×(Peak Reflectivity (max periods)-Peak Reflectivity(max periods−1)/(Peak Reflectivity(max periods))

where max periods is the maximum number of periods of the alternating layers giving rise to the maximum peak reflectivity.

In a typical Mo—Si multilayer the reflectivity trade-off per layer destroyed is approximately 0.4%. If a Layer A-Layer B combination is used, reflectivity trade-off may be less, for example 0.006%. Defectivity also arises in a multilayer deposition process.

In one embodiment the second layer containing group B will be the top most layer and closest to the EUV radiation. The first layer containing group A elements.

The multilayer may be used in combination with a hydrophobic layer, such as parylene, or a nanostructured hydrophobic material, which is interspersed between the metal layers or on top. The hydrophobic layer protects the metal layers from exposure or degradation in the air, or in fabrication processing. For example, when multilayers are used in photomasks, an absorber layer is patterned on top of the multilayer. The patterning requires a series of processing steps including deposition and etching which may introduce defects. Sometimes the mask is subjected to a cleaning process which exposes the multilayer to moisture and air. The hydrophobic material may be made from an inorganic base, e.g. Titanium Nitride or Titanium Dioxide, or be a self assembled monolayer or a passivation layer.

The multilayer or its constituents may be produced by deposition processes including sputtering, evaporation, thermal or e-beam evaporation, pulsed laser deposition, atomic layer deposition, molecular layer deposition, atomic layer epitaxy, ion beam deposition, e-beam deposition, electrodeposition, electro-formation, chemical vapor deposition, plasma enhanced deposition, physical vapour deposition, chemical vapor depositions, pulsed chemical vapor deposition, laser excitation, epitaxy, pulsed laser deposition, spin coating, drop coating, spray deposition, pyrolysis.

The Layer A- Layer B multilayer may also be used in conjunction with a capping layer, where the thickness of the capping layer is greater than 3 nm. Typically on an EUV photomask, the capping layer is made from Ruthenium and is 2.5 nm thick, as a greater thickness would substantially reduce overall reflectivity. With a group A-group B multilayer, the capping layer may be greater than 2.5 nm, providing substantially more protection from defects.

Smoothing of the multilayer films may be achieved by chemical mechanical polishing, template stripping, or AFM/SEM, electron beam or ion beam radiation, vapour annealing, atomic layer etching, nanoparticle slurry etching, or other planarization steps.

Defects in the group A- group B multilayer may subsequently be removed by cleaning process, e.g. a mask cleaning process.

The multilayer may be made on a substrate, where the substrate is curved, convex or concave, thus achieving 2 or 3 dimensional architecture.

In some cases the materials of group A or group B may differ from their standard stoichiometry.

In another embodiment group A and group B materials may be used on a two, three dimensional or periodic structure. The periodic structure may be on a lens, mask, mirror, filter, substrate, or other component. The combined structure may have nano sized elements incorporated within. Nanostructured elements can reduce the visibility of a defect. The nanostructure itself can provide a topology which prevents the defect from entering or can electromagnetically hide or cloak some part or all of the defect. The nanostructured element may be combined with a reflective, transmissive or absorptive element. The defect is usually obscured within a period of the periodic structure or nanostructure, or a distance equivalent to an integral distance of the wavelength.

The multilayer configuration may be characterized by SEM, AFM, EUV lightsource, AIMS or Actinic, FIB, Beamline, Reflectometry, Profilometry. In another embodiment, the material may be used in a characterization set-up. The material may serve as a reference in the set-up, or be measured in the characterization set-up. The characterization set-up may measure transmittance, reflectance, absorption, refractive index, scattering, roughness, resistivity, uniformity, bandwidth, angular range, depth of focus, electromagnetic intensity, wavelength sensitivity, amplitude or phase of the material. The characterization set-up may be an ellipsometer, a reflectometer, a spectrophotometer, x-ray diffraction tool (XRD), X-ray photo electron spectroscopy (XPS) or TEM. The characterization set-up may use a lightsource or a laser or table top x ray source, detector, camera, translation or rotational stage ,with one or more degrees of freedom. The characterization set-up may make electrical measurements to determine conductance or resistance.

The material combination, i.e. either multilayer or nanostructure may be designed to be spectrally reflective for one range of wavelengths and spectrally transmissive, absorbing, or reflective in a different direction for another range of wavelengths. e.g. if used in a pellicle, the materials may be configured to be transmissive in the EUV wavelength range and DUV wavelength range. If used on a coating, the materials may be reflective in the DUV and EUV wavelength ranges in different directions.

The materials of Layer A and Layer B may be used in an embodiment that forms part of a mask defect compensation configuration where the absorber layer pattern is a adapted to compensate for the phase changes introduced by defects.

The capping layer or protective layer may be formed by any charged material, e g a positively charged ionic material. The charged capping layer will deflect any incumbent charged particles e.g. defects that might impact the structure.

The capping layer may be formed by any material with an atomic number greater than that of Ruthenium. With a higher reflectivity multilayer, a capping layer may be chosen with a higher atomic number that has a greater associated ion stopping distance. This protects the underlying reflective structure. A higher atomic number means greater stopping distance but also increased absorption. However, with a higher reflectivity multilayer a more absorptive capping layer may be tolerated.

### BRIEF DESCRIPTION OF DRAWINGS

FIG. 1A and FIG. 1B schematically illustrate film stacks.

FIG. 2 reproduces a periodic table highlighting candidate materials for disclosed film stacks.

FIG. 3 is a graph of numerically modeled reflectivity spectra for 12-14 nm wavelengths.

FIGS. 4A-4D illustrate techniques for incorporating noble gas into solid A-layer.

FIG. 5 illustrates an example of a noble gas incorporated in an A-layer by flowing through an open nanostructure of one or more other A-layer materials.

FIG. 6 is a simplified diagram of absorption in non-porous and porous absorbing media. Although the underlying physics of these effects is much more complex for EUV/SX and sub-wavelength features that for the first-order macroscopic ray optics pictured, the end results are at least qualitatively similar.

FIGS. 7A-7B illustrate the effect of porous layers on the penetration depth of light in a film stack.

FIGS. 8A-8B illustrate ablation of optical coatings by EUV/SX light sources.

FIGS. 9A-9D illustrate film stacks with extra layers to mitigate the effects of ablation.

FIGS. 10A-10B illustrate the effect of nanostructures on visibility of defects.

FIG. 11 is a process flowchart for forming A-B film stacks on a substrate. Optical fabrication may have many steps, not all of which would be affected by the disclosed subject matter. A fabrication method may therefore include other processes before and after those illustrated, or intermediate steps between those illustrated, and may still be within the scope of disclosure.

### DETAILED DESCRIPTION OF IMPLEMENTATION MODES

The following description provides a number of specific details of embodiments to further readers' understanding of the presented concepts. However, alternate embodiments of the presented concepts may be practiced without some or all of these specific details. In other instances, well-known process operations have not been described in detail so as to not unnecessarily obscure the described concepts. While some concepts will be described in conjunction with the specific embodiments, it will be understood that these embodiments are not intended to be limiting.

### Definitions

Herein, the following terms shall have the following meanings:

Approximately: ±10% unless otherwise stated.

Atoms, molecules: include isotopes, ions

Above (a layer): May be directly on the layer, or may be above the layer with intervening structures or layers there between.

Combination (of chemical elements): May include, without limitation, an element compound, alloy, mixture, micro- or nanolaminate, isotopes, ions, ternary material , non stoichiometric material.

Essentially: Active ingredients, intentionally added. Inactive ingredients or trace impurities that do not affect the coating's function may also be present in formulations within the scope of this disclosure.

Include: Include, but not be limited to, unless otherwise stated.

EUV/SX/DUV: Any range of wavelengths from 0.1 nm to 250 nm.

Layer: A stratum of film May cover all of substrate or part of substrate; may include sub-layers, gradients, interfacial zones, or structures. May be applied by atomic or molecular layer deposition, chemical vapor deposition (incl. plasma-enhanced, pulsed), dip coating, drop coating, electro-formation (e.g., electrodeposition, electroplating), epitaxy, evaporation (e.g., thermal, e-beam), laser deposition (incl. laser excitation of one or more precursors), particle-beam deposition (e.g., electrons, ions), physical vapor deposition, pyrolysis, spin coating, spray deposition sputtering. or any other known method suitable for the layer material and substrate.

Nanostructure, nanoscale: Having a size or a feature size between about 1 nm and 150 nm.

Substrate: A solid object coated with, or to be coated with, the disclosed EUV/SX interference coating(s). A “substrate” need not be perfectly bare, but may include previously-formed layers or structures.

Workpiece: An object being coated or otherwise processed by EUV/SX radiation transmitted or reflected by the disclosed EUV/SX coating(s) on one or more optical elements. e.g. a wafer. May be, e.g., a generalized substrate or a superstrate, but need not be the “substrate” of a EUV/SX optical element itself.

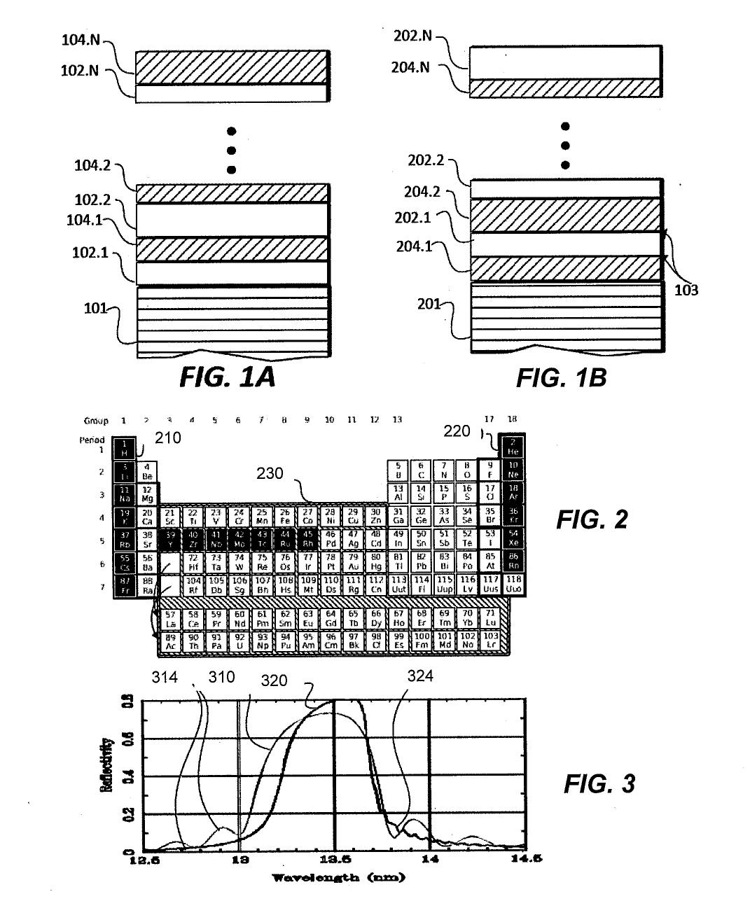

FIG. 1A and FIG. 1B schematically illustrate film stacks of multiple A/B layer periods.

Substrate 101 may be flat as shown, or non-flat (curvature, micro- or nano-structures, etc.) The film stack includes a first A-layer 102.1. a first B-layer 104.1, a second A-layer 102.2, a second B-layer 104.2, a topmost (Nth) A-layer 102.N, a topmost (Nth) B-layer 104.N, and (not shown) third through (N−1)th A- and B-layers between B-layer 104.2 and A-layer 102.N. N may be 4-100, depending on the application. The A-layers essentially include at least one of an alkali metal, a noble gas, a halogen, or an alkaline earth metal with a higher atomic number than beryllium. The B-layers essentially include at least one of a transition metal, a lanthanide, or an actinide. Interfaces 103 between A-layers and B-layers may include other substances; for example, moisture barriers or oxygen barriers. Additional layers or structures may be formed under or over the stack.

The A-layers may or may not all have the same composition or thickness. Likewise, the B-layers may or may not all have the same composition or thickness. Transmissive optics for the EUV/SX spectrum have traditionally been very difficult to fabricate because all materials absorb these wavelengths. The goal may be advanced by using these A-B coatings, which may be more transmissive than historical coating materials, on a reasonably non-absorbing substrate such as a thin pellicle.

In general, the A-layers are selected for low absorption and the B-layers are selected for high reflectivity. The dimensions of classical interference coatings are not necessarily the best-performing in EUV/SX where reflection is dominated by interfacial scattering. Numerical finite-element analysis with Maxwell's equations may more reliably yield an optimum set of materials and dimensions.

FIG. 1B schematically illustrates a film stack of multiple B/A layer periods. Substrate 201, which may include layers or structures underneath those illustrated, has a B-layer 204.1 closest to the substrate rather than the A-layer 202.1 of FIG. 1A. The B/A pattern repeats with second B-layer 204.2 second A-layer 202.2 , and any number (e.g., 10-400) of additional periods up to the total number N, with Nth A-layer 202.N on top and Nth B-layer 204.N immediately below it. The stacks may have either a B-layer or an A-layer on top, and the number of layers need not necessarily be even.

FIG. 2 reproduces a periodic table highlighting candidate materials for disclosed film stacks. A-layer materials occupy areas 210 and 220 delineated by a black background: Group 1, the alkali metals; Group 2, the alkaline earth metals (except for beryllium); Group 7, the halogens; and Group 8, the noble gases. A-layers may include one of these materials alone or a combination of them. These elements and their combinations may be less absorptive in the EUV/SX spectrum because their outer electron shells are full (noble gases), nearly full (halogens) or nearly empty (alkali and alkaline-earth metals). At 13.5 nm, the least absorptive may be the Group 1 and Group 18 elements and the most reflective may be Period 5 of Groups 3-9 (Y, Zr, Nb, Mo, Tc, Ru, Rh).

As a general rule, higher atomic numbers within these groups are least likely to absorb EUV/SX and easier to combine because the outer electrons are shielded and therefore less tightly bound than the inner electrons. Exceptions have been noted: for example, krypton and xenon form more compounds more easily than helium or neon, but at this writing a stable radon compound may not have been formed. However, it may be possible to trap or inject radon as unbound atoms in a structure made of one or more elements from the other groups. B-layer materials are located in area 230, which has a hatched background: the transition metals, lanthanides, and actinides of Groups 3-12.

FIG. 3 is a graph of numerically modeled reflectivity spectra for 12-14 nm wavelengths.

Curve 310 resulted from a finite-element electromagnetic model of a. conventional Mo—Si film stack, showing a peak at about 67% that reasonably matches reported measurements. The peak is higher at about 80%, narrower at about 5 nm and the sidebands are absent although there may be some low-amplitude ringing 324.

To use in an A-layer, a noble-gas compound may preferably be solid and stable at typical ambient process temperatures, although compounds that are gaseous within this temperature range may sometimes be incorporated in the same way as unbound gas atoms. Additionally because the A-layer is intended to provide a low-EUV/SX-absorbance segment of optical path. Halides and hydrates are less absorbing.

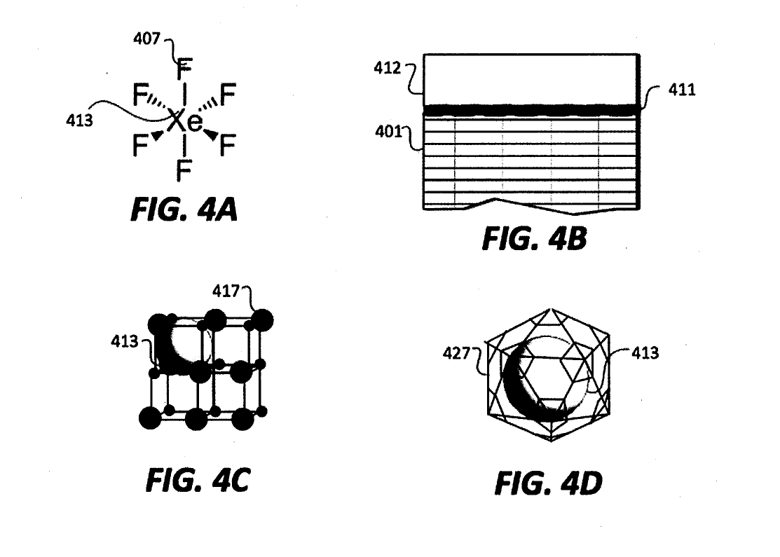

As illustrated in FIG. 4A, potentially usable xenon compounds 407 include fluorides XeF₂, XeF₄, XeF₆.; hydrates (e.g., those made by compressing Xe in water); and other halides and complex ions. FIG. 4B illustrates a substrate 401with an A-layer 412 above the substrate (some very simple embodiments may use a single layer of A-layer material and no B-layers) and an oxygen barrier 413 between the A-layer and the substrate. Some noble-gas compounds e.g., XeF₆, are strong oxidizers that may attack even an oxide-glass substrate. Additionally or alternatively, if the noble-gas-compound layer is exposed to ambient air (including, without limitation, during manufacture, storage, installation, some types of use, cleaning, or repair), another source of oxygen. In some embodiments, an oxygen barrier 413 may be interposed above the A-layer, below it, or both.

FIG. 4C illustrates a clathrate or cage compound including, without limitation, free noble gas atoms 413 trapped in a crystalline lattice 417. Noble-gas atoms in cage compounds are not truly bonded, but quasi-mechanically trapped in structural interstices. A number of lattices have been observed to trap Xe, Kr, and Ar, but Ne and He are often small enough to escape. FIG. 4D illustrates a carbon fullerene cage compound with noble gas atom 413 trapped in fullerene shell 427. The C₆₀ fullerene, for example, is known to trap He, Ne, Ar, Kr, Xe. However, an ideal fullerene for use as an A-layer would have a low density of carbon atoms to limit EUV/SX absorption.

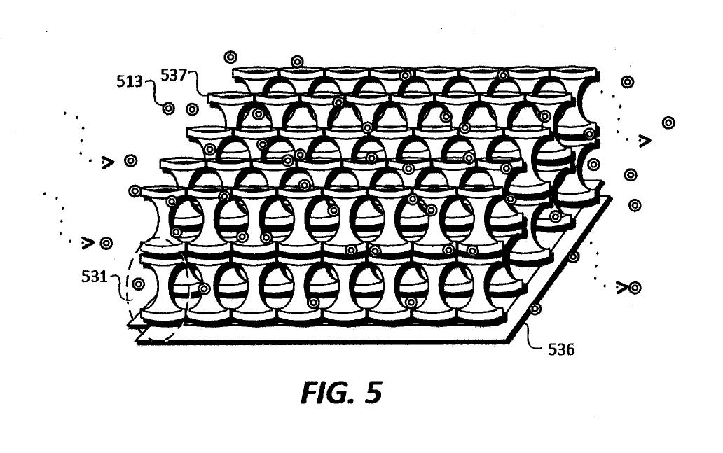

FIG. 5 illustrates an example of a noble gas incorporated in an A-layer by flowing through an open nanostructure of one or more other A-layer materials. Nanopillars 531 are organized in an array 537 with interstitial openings. The noble gas may passively settle into the openings of the nanostructure as a result of a soak, or may be actively driven into and through the openings by a gas-flow system. The nanostructure may be open on top as shown, or may have a smooth cover layer on top similar to base layer 536 shown here on the bottom.

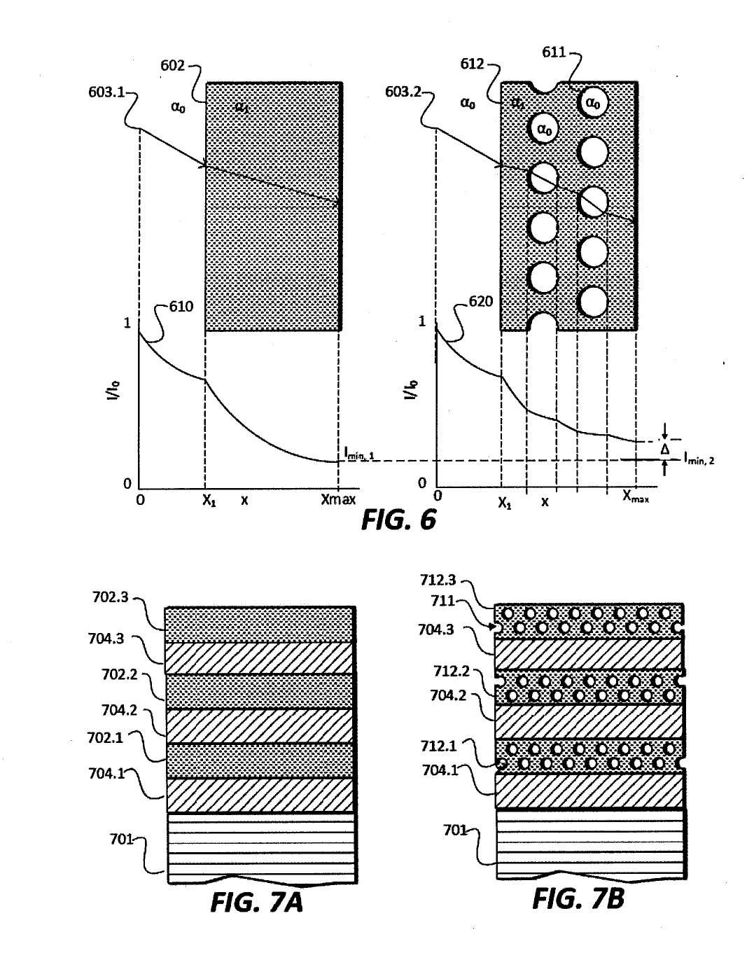

FIG. 6 is a simplified diagram of absorption in non-porous and porous absorbing media. Although the underlying physics of these effects is much more complex for EUV/SX and sub-wavelength features that for the first-order macroscopic ray optics pictured, the end results are at least qualitatively similar.

Plane-parallel windows 602 and 612 are made of the same bulk material (e.g., silicon or an A-layer material) with absorption coefficient α₁. Both are immersed in the same surrounding medium (e.g., vacuum or air) of absorption coefficient α₀. Window 602 is solid, while window 612 has pores 611 filled with the α₀ medium.

Idealized light pencils or rays 603.1 and 603.2 have initial intensity I₀ at their respective x=0 positions in the α₀. By Lambert-Baer's law the intensity at any x is . Where light travels through media with different absorption coefficients a, its intensity will always be exponentially decreasing, but the parameters of the exponential curve will change when the ray enters and exits the different media

Curve 610 represents the intensity of the ray 603.1. Initially it decreases proportional to . When it enters window 612 at X₁, the coefficient changes, and from X1 to Xmax the intensity decreases proportional to until it reaches I_{min,1} at Xₘₐₓ.

Curve 620 represents the intensity of the ray 603.2. Initially it decreases proportional to . When it enters window 612 at X₁, the coefficient initially changes, and while it travels through the solid bulk material, the intensity decreases proportional to. However, while it crosses pores 611, the intensity decreases proportional to , offsetting the curve twice and causing its I_{min,2} at Xₘₐₓ, to be greater than I_{min,1} by a difference Δ. Pores filled with any lower-absorption material (not necessarily the surrounding medium) will have a similar effect, reducing the thickness-dependent absorption of the window (or the thin-film layer).

FIGS. 7A-7B illustrate the effect of porous layers on the penetration depth of light in a film stack.

When tens of layers in a reflective stack all absorb incident light, some of the bottom layers may never receive any light of a sufficient intensity to contribute measurably to the reflection. The higher the absorption coefficient, the shorter the distance that the light penetrates into the stack.

The stack of FIG. 7A has non-porous B-layers 704.1-704.3 alternating with non-porous “non-B”-layers 702.1-702.3 (these may or may not be made of the disclosed A-layer materials). In low-intensity EUV/SX applications where film-stack damage is slow to insignificant, layers 704.1, 702.1, and 704.2 will not be used.

In FIG. 7B, the non-porous B-layers 704.1-704.3 are identical to those in FIG. 7A. The “not-B”-layers 712-1-712.3 are made of the same bulk material as layers 702.1-702.3 in FIG. 7A, but are porous rather than solid. Adding the pores allowed the incident light to penetrate down to 712.1, two layers further than in the stack of FIG. 712A.

In sub-wavelength EUV/SX film stacks, reflection may be treated as arising from interfacial scattering. Having more interfaces contribute to the reflection may reduce the effect of a defect on any one interface.

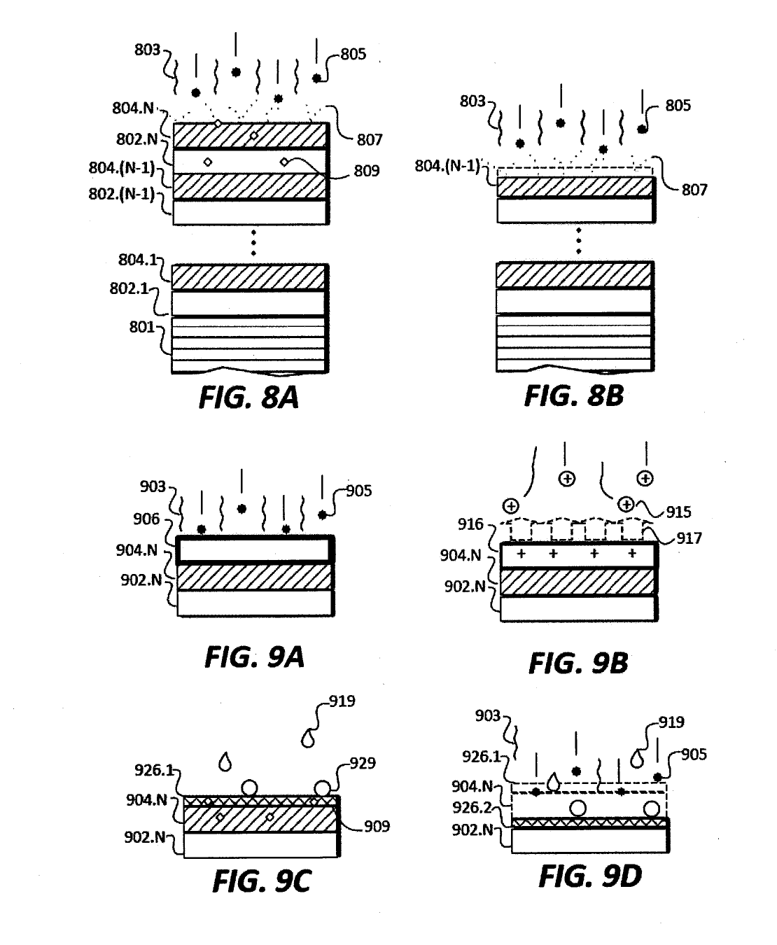

FIGS. 8A-8B illustrate ablation or erosion of optical coatings by EUV/SX light sources.

FIG. 8A illustrates an undamaged coating on a “new” optical element placed in a process system. Substrate 101 is the base optical element, not the process workpiece (see Definitions: Substrate, Workpiece). In some embodiments, substrate 101 may include layers or structures underneath those illustrated. Above substrate 101 is a 2N-layer film stack with sub-wavelength layer thicknesses: A-layers 802.1 (bottom) through 802.(N−1) (second from top) and 802.N (topmost A-layer) alternate with B-layers 804.1 (bottom) through 804.(N−1) (second from top) and 804.N (topmost B-layer). In some embodiments, the A-layers are made of materials from at least one of Group 1, Group 18, Group 17, or period 3-7 of Group 2 on the periodic table. In some embodiments, the B-layers are made of materials from at least one of Groups 3-12 on the periodic table. In some embodiments, one or more of the A-layers may be porous. As illustrated, an A-layer is on the bottom of the stack and a B-layer is on the top, but the order of layers may be reversed and still fall within the scope of disclosure.

EUV/SX radiation 803 from an EUV/SX source falls on top layer 804.N. EUV/SX sources may include synchrotron radiation or plasmas produced from, e.g., sprays of molten metal such as tin (Sn). Particles 805 (a by-product of the EUV/SX source) may also be present. In longer-wavelength systems, one or more pellicles (very thin beamsplitters) may intercept the particles before they reach other optics, but the high EUV/SX absorbance coefficients of conventional pellicle materials has hindered their use in this spectrum.

Either or both types of source output may ablate A-layers or B-layers, causing ablation ejecta 807 to detach from top stack layer 804.N. Defects 809 (such as inclusions, voids, lattice distortions, etc.) may be present in A-layers and/or B-layers. Defects 809 may be caused by exposure to radiation and particles from the EUV/SX source, or may be created earlier by fabrication or maintenance processes such as etching, deposition, cleaning, and the like.

FIG. 8B illustrates a worn, partially ablated film stack after sustained exposure to radiation and particles from a EUV/SX source such as a plasma. As illustrated, 804.(N−1), the B-layer that was originally second from the top, has been uncovered & is now the top layer. Further exposure to EUV/SX radiation 803 & to particles 805 produced by the source as a by-product) 805 will transform more of layer 804.(N−1) into ablation ejecta 807.

Some coating stacks within the scope of disclosure include extra layers to extend the useful life of the optical element. Even if some top layers are ablated off, the optical element will still function

FIGS. 9A-9D illustrate film stacks with extra layers to mitigate the effects of ablation.

FIG. 9A illustrates a film stack with a capping layer. Capping layer 906 may be formed over Nth A-layer 902.N or Nth B-layer 904.N, whichever is topmost. Unlike the rugged but somewhat high-absorption ruthenium or carbon capping layers in common use, which may be restricted to thicknesses of 2.5 nm or less to constrain EUV/SX absorption, capping layer 906 has lower absorption and therefore may be made thicker than 2.5 nm to protect the underlying film stack for a longer time. The lower absorption is achieved by making capping layer 106 from large-atom or large-molecule A-layer materials including, without limitation, one or more of K, Na, Rb, Cs, Kr, Xe, Sror a combination. In general, the higher-atomic-number A-layer materials resist damage due to their high interatomic potential and/or tensile strength.

FIG. 9B illustrates a film stack with a charged capping layer that repels or deflects incoming particles of like charge. For example, most particles emitted by a molten-tin-spray plasma are positively charged, indicating that a charged capping layer 916 with sufficient positive potential may prevent them from reaching the film stack and creating defects. As illustrated, Nth A-layer 902.N or Nth B-layer 904.N (whichever is topmost). Charged capping layer 916 may be charged by being fabricated with ion-containing material, a non-stoichiometric material, over lower layers that are ionic or non-stoichiometric, or by connecting an ungrounded electrical contact in-situ. When charged particles 915 exit the EUV.SX source, electrostatic field 917 from charged top layer 916 repels or deflects charged particles 915 before they reach, and potentially damage, the underlying film stack.

FIG. 9C illustrates a film stack with a hydrophobic layer over Nth A-layer 902.N or Nth B-layer 904.N, whichever is topmost. Tin droplets from a tin plasma source 919 incident on the optic or photomask may be effectively prevented from damaging the multilayer coating by a hydrophobic layer which changes the the contact angle of the droplet and surface energy on the coating, allowing it to be cleaned easily.

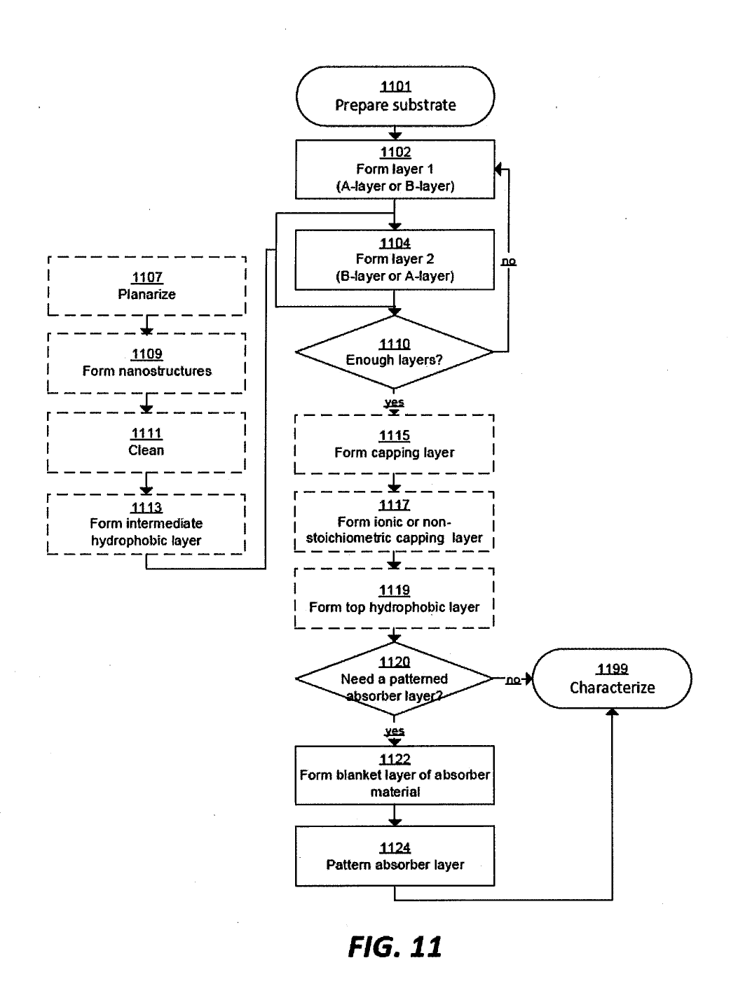

As illustrated, hydrophobic top layer 926.1 keeps adsorbed tin 929 from being absorbed by A- and B-layers. Possibly suitable types of hydrophobic top layer 926.1 include parylene, silane, hydrocarbon monolayers, an oxide or nitride of a B-layer (e.g., TiN or TiO2 on a Ti B-layer), passivation materials, self-assembling monolayers. Alternatively, the hydrophobic quality may be added by nanostructures rather than by specific materials that are not already part of the stack. The nanostructure approach offers the potential added advantage of reducing visibility of defects 909 (see FIG. 11).

FIG. 9D illustrates multiple hydrophobic layers to maintain protection against moisture as successive A-B layers are ablated. The stack in FIG. 9D initially resembled that of FIG. 9C, but over time the top hydrophobic coating 926.1 and immediately underlying B-layer 904.N were ablated away by radiation 903 and particles 905. However, subsequent ablation uncovered intermediate hydrophobic coating 926.2, which now protects the new top layer, A-layer 902.N.

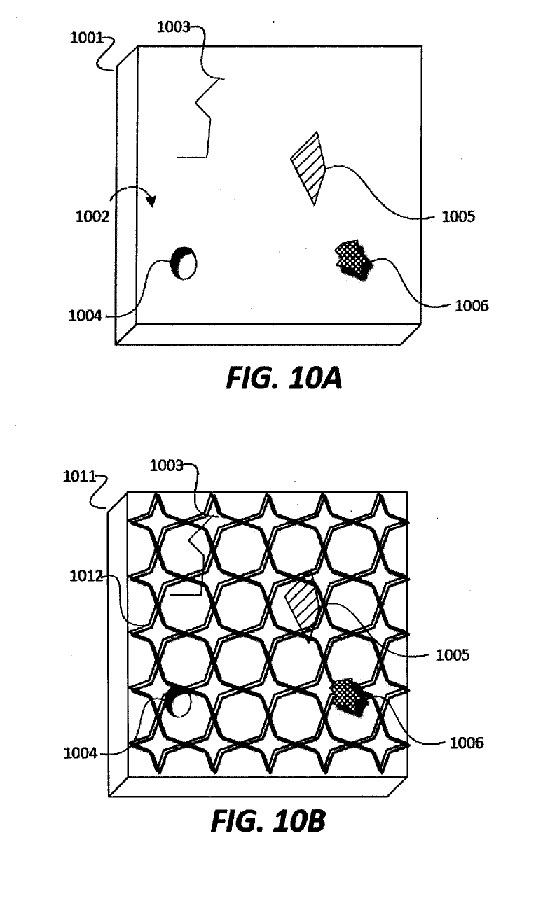

FIGS. 10A-10B illustrate the effect of nanostructures on visibility of defects.

FIG. 10A shows a smooth layer with nanoscale defects. Layer 1001 has a smooth surface 1002 and defects 1003-1006. Line defect 1003, pit defect 1004, grain defect 1005, and particle defect 1006 are all highly visible on smooth surface 1002.

FIG. 10B shows a nanostructured layer with the same defects. Layer 1011 is patterned with a raised nanostructure 1012. Line defect 1003, pit defect 1004, and grain defect 1005 are notably less visible, because their degradation of reflectivity has less impact.

The nanostructure itself can provide a topology which prevents the defect from entering or can electromagnetically hide or cloak some part or all of the defect. The nanostructured element may be combined with a reflective, transmissive or absorptive element. The defect is usually obscured within a period of the periodic structure or nanostructure, or a distance equivalent to an integral distance of the wavelength.

FIG. 11 is a process flowchart for forming A-B film stacks on a substrate. Optical fabrication may have many steps, not all of which would be affected by the disclosed subject matter. A fabrication method may therefore include other processes before and after those illustrated, or intermediate steps between those illustrated, and may still be within the scope of disclosure.

Substrate preparation operation 1101 may include cleaning, passivating, formation of underlying layers or structures, or any other prerequisite for forming the A-B stack.

Layer 1 formation operation 1102 may either produce an A-layer or a B-layer, depending on which is intended to be the bottom layer. Any suitable known technique for forming a layer of sub-wavelength thickness from the selected A-layer or B-layer materials may be used.

Optionally, the layer just formed may be smoothed or planarized in operation 1107. Optionally, a nanostructure may be formed in operation 1109. Optionally, the layer may be cleaned in operation 1111. Optionally, the new layer may be covered with an intermediate hydrophobic layer in operation 1113.

In operation 1104, the next layer is formed: a B-layer if operation 1102 formed an A-layer, or a B-layer if operation 1102 formed an A-layer.

Optionally, the layer just formed may be smoothed or planarized in operation 1107. Optionally, a nanostructure may be formed in operation 1109. Optionally, the layer may be cleaned in operation 1111. Optionally, the new layer may be covered with an intermediate hydrophobic layer in operation 1113.

At decision 1110, if all the intended layers in the stack have not yet been formed, return to operation 1102 to form another layer pair. If all the intended layers in the stack have been formed:

Optionally, operation 1115 may form a capping layer of large-atom elements or combinations from Group 1 and/or Group 18 on the periodic table. Optionally, operation 1117 may form an ionic or non-stoichiometric capping layer that may retain a charge to repel or deflect like-charged particles. In some embodiments, operation 1115 and operation 1117 may be combined to form a charged capping layer of large-atom Group 1/Group 18 elements or combinations.

Optionally, operation 1119 may form a top hydrophobic layer. In some embodiments, operation 1119 may precede operation 1115 and/or operation 1117.

At decision 1120, if the product being made does not need a top absorber layer, proceed to characterization operation 1199. If the product being made does need a top absorber layer (for example, it will be a photomask, reticle, or similar element) continue to absorber material layer formation operation 1122, followed by absorber material patterning operation 1124. In some embodiments, the absorber layer may be patterned as it is being formed, so that operation 1122 and operation 1124 are concurrent. Once the patterned absorber layer is in place, proceed to characterization operation 1199.

### INDUSTRIAL APPLICABILITY

The A/B sub-wavelength coatings disclosed herein may be useful for a variety of EUV/XS optical applications, including, without limitation, high-resolution photolithography; analytical chemistry such as identifying chemicals by their resonances; astronomy such as mapping, planets, nebulae and stellar atmospheres that emit EUV/SX; biology such as the study and/or imaging of biomaterial samples; or medicine such as imaging and contaminant cleaning.

The preceding Description and accompanying Drawings describe example embodiments in some detail to aid understanding. However, the scope of the claims may cover equivalents, permutations, and combinations that are not explicitly described herein.

Various processing applications, for example for semiconductors, integrated optics, and other miniaturized component fabrication, may use the disclosed films and film stacks on any reflective (or, if and when available, transmissive) optics that steer the source light or image the photomask or other pattern source. For example, a process chamber may include a workpiece holder to position the wafer or other type of workpiece, and a light source or a port admitting light into the chamber from a remote source (e.g., a remote plasma). A collector may be positioned to capture some of the source output light that would otherwise travel in un-usable directions, and redirect it along a first optical path from the light source to the photomask. In some embodiments, the collector may collimate or focus its output beam. Other optics may be positioned in the first optical path to steer or reshape the beam. For example, a beam scrambler or diffuser may spatially divide or scatter some of the light so that the intensity profile across the photomask is flatter than it might otherwise be. Beamsplitters or gratings may divert unwanted wavelengths to keep them from blurring the image on the workpiece.

Many EUV/SX process systems use a reflective photomask with absorbing areas to provide contrast to the pattern. One or more mirrors (or alternatively refractive or diffractive lenses) may be positioned in a second optical path from the photomask to the workpiece, to provide an image of the photomask on the workpiece.

Any of the reflective, transmissive, wavelength-selective, diffractive, scattering, or wave-guiding optics in such systems may potentially include the disclosed films and/or film stacks.

While the above detailed description has shown, described, and pointed out novel features as applied to various embodiments, it will be understood that various omissions, substitutions, and changes in the form and details of the devices or algorithms illustrated can be made without departing from the spirit of the disclosure. Thus, nothing in the foregoing description is intended to imply that any particular feature, characteristic, step, module, or block is necessary or indispensable. As will be recognized, the processes described herein can be embodied within a form that does not provide all of the features and benefits set forth herein, as some features can be used or practiced separately from others. The scope of protection is defined by the appended claims rather than by the foregoing description.

We claim:

1. An optical element with an operating wavelength λ, the optical element comprising:
a substrate; and
a first layer above the substrate;
wherein a thickness of the first layer is less than the wavelength λ;
wherein the first layer is essentially composed of alkali metal, noble gas, halogen, non-beryllium alkaline earth metals, or their combination;
wherein the first layer has a lower absorption at λ than a non-porous
stoichiometric silicon layer of equal thickness; and
wherein 0.1 nm≦λ≦250 nm.

2. The optical element of claim 1, further comprising an oxygen barrier above or below the first layer.

3. The optical element of claim 1, further comprising a hydrophobic layer above the first layer.

4. The optical element of claim 3, wherein the hydrophobic layer comprises a nanostructure.

5. The optical element of claim 1, further comprising:
a second layer above or below the first layer;
wherein a thickness of the second layer thickness is less than the wavelength X;
wherein the second layer is composed essentially of transition metal, lanthanide, actinide, or one of their combinations; and
wherein 0.1 nm≦λ≦250 nm.

6. The optical element of claim 5, further comprising a laminate of 41 to 400 additional layers having optical properties of the first layer alternating with additional layers having optical properties of the second layer.

7. The optical element of claim 5, wherein at least one of the first layer or the second layer comprises a nanostructure that reduces the visibility of defects.

8. A product, comprising:
a substrate;
a first layer of optical material formed above the substrate and compatible with wavelengths between 0.1 nm and 250 nm; and
a capping layer formed above the first layer;
wherein the capping layer consists essentially of alkali metal, noble gas, halogen, non-beryllium alkaline earth metals, or their combination.

9. The product of claim 8, wherein the capping layer has an atomic number greater than an atomic number of ruthenium.

10. The product of claim 8, wherein the capping layer is charged at a same polarity as particles present in an operating environment.

11. The product of claim 10, wherein the capping layer comprises ions.

12. The product of claim 10, wherein the capping layer is electrically coupled to an ungrounded voltage source.

13. The product of claim 8, further comprising a hydrophobic layer above the capping layer.

14. An optical reflector, comprising:
a substrate;
a first layer above the substrate; and
a second layer above the substrate and above or below the first layer;
wherein the first layer is porous;
wherein the first layer has a lower absorption coefficient at an operating wavelength λ than the second layer;
wherein the.second layer is non-porous;
wherein a thickness of the first layer is less than λ; and
wherein a thickness of the second layer is less than λ.

15. The optical reflector of claim 14, wherein the first layer comprises a 2-D or 3-D nanostructure including spaces that render the layer porous.

16. A method, comprising:
preparing a substrate: and
forming a first layer above the substrate;
wherein the first layer is essentially composed of alkali metal, noble gas, halogen, alkaline earth metal except for beryllium, or one of their combinations;
wherein a thickness of the first layer is less than an operating wavelength λ; and
wherein 0.1 nm≦λ≦250 nm.

17. The method of claim 16, further comprising:
forming a second layer above or below the first layer;
wherein the second layer is essentially composed of transition metal, lanthanide, actinide, or one of their combinations;
wherein a thickness of the second layer is less than an operating wavelength k; and
wherein 0.1 nm≦λ≦250 nm.

18. The method of claim 16, wherein the layer is formed by a technique comprising at least one of sputtering, evaporation, wide angle deposition, rotational sputtering evaporation, pulsed laser deposition, atomic layer deposition, pulsed CVD, chemical vapor deposition, molecular layer deposition, atomic layer epitaxy, ion beam deposition, e-beam deposition, electrodeposition, electro-formation, chemical vapor deposition, plasma enhanced deposition, vapor deposition, laser excitation or epitaxy.
